(19) United States
(12) Patent Application Publication
(10) Pub. No.: US 2010/0194207 A1
(43) Pub. Date: Aug. 5, 2010

(54) WIRELESS POWER TRANSFER WITH LIGHTING

(76) Inventor: David S. Graham, Mountain View, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/700,418

(22) Filed: Feb. 4, 2010

Related U.S. Application Data
(60) Provisional application No. 61/149,862, filed on Feb. 4, 2009.

(51) Int. Cl. H02J 17/00

(52) U.S. Cl. 307/104; 307/157

(57) ABSTRACT

A device including a wireless power transmitter is connected to a light fixture rather than a standard electrical outlet. Optionally, the device also includes at least one light source or includes at least one socket for a light source. Thus, the device connected to the light fixture can output power from the wireless power transmitter and light from the light source. In one embodiment, a power splitter enables independent control over powering the light and the wireless electricity transmitter. This feature allows, for example, the light to be turned off or on while the wireless electricity transmitter remains on. In some embodiments, the device including the wireless power transmitter has the form of a light bulb or light tube, whereas in other embodiments, the device does not have the form of a light bulb or light tube.

### CROSS-REFERENCE TO RELATED APPLICATION

This application claims the benefit of U.S. Provisional Application No. 61/149,862, filed on Feb. 4, 2009, which is hereby incorporated by reference in its entirety.

### BACKGROUND OF THE INVENTION

1. Field of the Invention

This invention relates to systems for wireless power transfer. More specifically, it relates to a wireless power transmitter connected to a light fixture.

2. Description of the Related Art

Several systems have been developed to provide wireless electricity to devices. One example is the PowerBeam optical system which has been developed by PowerBeam of Mountain View, Calif. The PowerBeam optical system requires line-of-sight to the device being powered. Another is a magnetic resonant system such as that of WiTricity, developed by researchers from MIT. Still another is an RF system such as that developed by PowerCast LLC of Pittsburg, Pa.

All of these systems face the same two issues with respect to their transmitters: 1) the position of the transmitter is important to enabling the transmitted power to reach the receivers; and 2) the transmitter requires electricity to operate. Until now, all proposals have solved these issues separately, by putting a wireless electricity transmitter on a post or on a wall, and then plugging the transmitter into an outlet or hardwiring to available electricity.

Although intermediate parts to take power from screw-in (unballasted) light fixtures are available at hardware stores, these intermediate parts are not suitable for wireless power. An example of one such prior art device 100 is illustrated in FIGS. 1A and 1B. The device 100 includes a screw mount 10 where the device 100 can be screwed into a light socket, a threaded connector 13 where a light bulb can be screwed into the device 100, and an outlet 11 into which an electrical plug may be inserted to draw power through the device 100. However, because the standard electrical outlet in the US has a height of approximately 30 mm, intermediate parts such as the example illustrated in FIGS. 1A and 1B, force anything plugged into a standard electrical outlet to stand-off by at least 30 mm. As a result, recessed ceiling lights would no longer be recessed, which defeats the aesthetics and safety reasons for recessing them. Also, power to the outlet would only be available when the light was turned on. In many cases, it would be desirable to have the light off but the wireless power transmitter still transmitting power.

### SUMMARY OF THE INVENTION

Embodiments of this invention solve the position and power requirements of wireless power systems simultaneously. A device including a wireless power transmitter is connected to a light fixture rather than a standard electrical outlet. Optionally, the device also includes at least one light source or includes at least one socket for a light source. Thus, the device connected to the light fixture can output power from the wireless power transmitter and light from the light source. In one embodiment, a power splitter enables independent control over powering the light and the wireless electricity transmitter. This feature allows, for example, the light to be turned off or on while the wireless electricity transmitter remains on. In some embodiments, the device including the wireless power transmitter has the form of a light bulb or light tube, whereas in other embodiments, the device does not have the form of a light bulb or light tube.

### BRIEF DESCRIPTION OF THE DRAWINGS

FIG. 1A is an illustration of a side view of a prior art device that may be screwed into a light fixture to provide an outlet.

FIG. 1B is an illustration of a perspective view of a prior art device that may be screwed into a light fixture to provide an outlet.

FIG. 2 is a high-level block diagram of a device in accordance with one embodiment of the invention.

FIG. 3 shows one embodiment of a device including a wireless power transmitter with light bulb form.

FIG. 4A is an illustration of a bottom view of a standard fluorescent light fixture.

FIG. 4B is an illustration of an isometric view of a standard fluorescent light fixture.

FIGS. 5A and 5B illustrate the fixture shown in FIGS. 4A and 4B as modified to include a built-in wireless power transmitter, in accordance with one embodiment.

FIGS. 5C and 5D illustrate an isometric view and a front view, respectively, of a fixture modified to include a built-in wireless power transmitter, in accordance with one embodiment.

FIGS. 6A and 6B are a bottom view and an isometric view, respectively, of an intermediate that takes power from the socket and switches power between the light and the wireless power transmitter.

FIG. 7 shows one embodiment of a device wherein the wireless power transmitter is not in light bulb form.

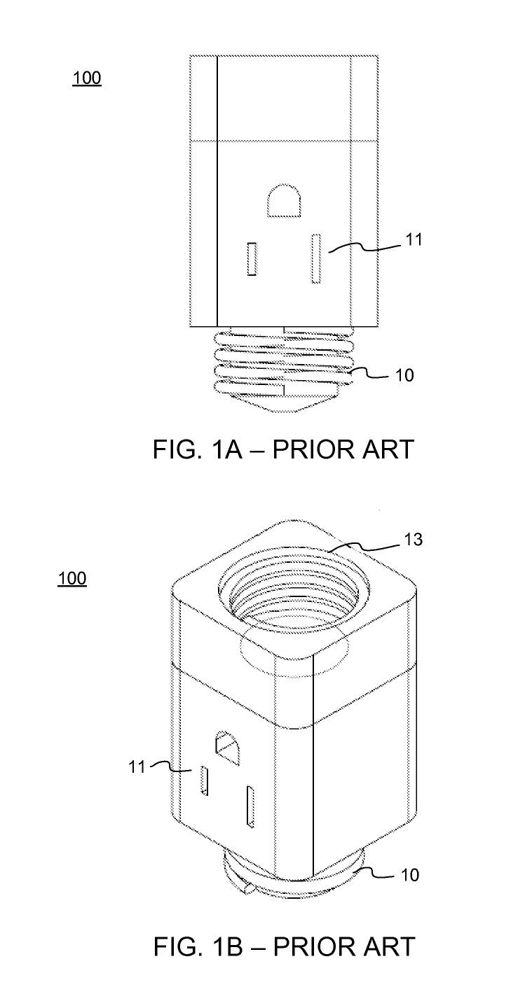

### DETAILED DESCRIPTION OF THE EMBODIMENTS

Embodiments of this invention include a device including a wireless electricity transmitter that is connected to a light fixture rather than to a standard electrical outlet, such as a wall outlet. The device may also include a light, so that the combined features of the device outputs both power and light. Section 1 describes the features of the device that allow for the combination of a wireless power transmitter and lighting. Section 2 describes embodiments where a device including the wireless power transmitter is integrated into the form of a light. Section 3 describes embodiments where the device including the wireless power transmitter is not integrated into the form of a light.

### 1. Combination of a Wireless Power Transmitter and Lighting

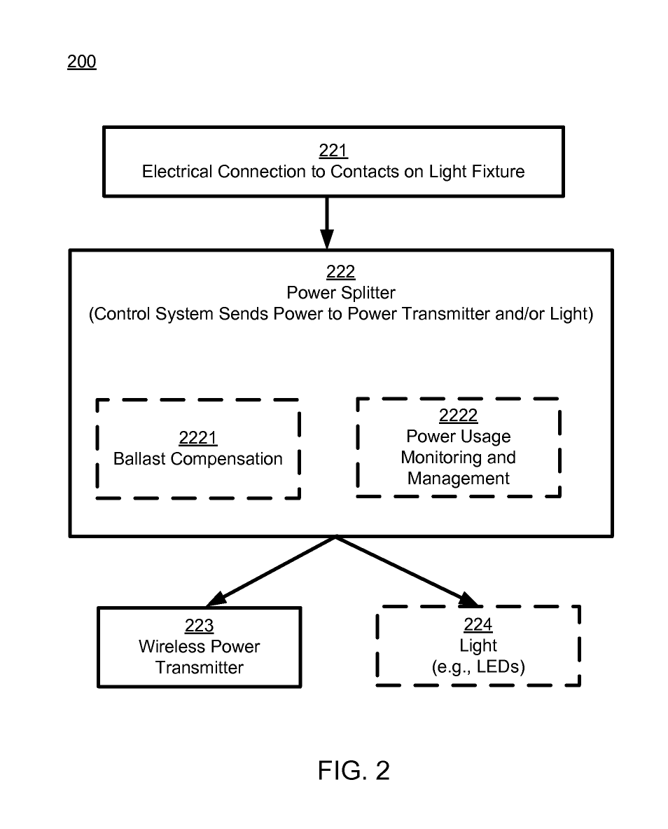

FIG. 2 is a high-level block diagram of a device 200 in accordance with one embodiment of the invention. As shown in FIG. 2, the device 200 includes an electrical connection to contacts on the light fixture 221, a power splitter 222, a wireless power transmitter 223, and a light 224. The solid lines surrounding the electrical connection to contacts on the light fixture 221, the power splitter 222, and the power transmitter 223 designate features of the invention in the preferred embodiment. The dotted lines surround additional optional features that may be present in some embodiments. The arrows illustrate the flow of power through the device 200.

The electrical connection to contacts on the light fixture 221 enables the device 200 to be powered through a light fixture that is, for example, hardwired into an electrical system, such as the electrical wiring in a house or other building. Thus, no external additional power source is needed to supply the power requirements for operating the light 224 and/or the wireless power transmitter 223. In the present invention, electricity is continually provided to the fixture, without regard to the state of the light 224 being on or off. In other words, the light 224 being off does not interrupt the electricity to the fixture. In one embodiment, the electrical connection to contacts on the light fixture 221 is a screw mount for the device 200.

The electrical connection to contacts on the light fixture 221 is connected to a power splitter 222 in a preferred embodiment. The power splitter 222 provides power selectively to the wireless power transmitter 223 and the light 224, and thus is electrically intermediate between each of them and the electrical connection to contacts on the light fixture 221. The power splitter is configured, in one embodiment, to enable the light 224 to turn on and off, for example, in response to a wireless or wired signal from a switch, for example, on a wall or in a remote control, while leaving the wireless electricity transmitter 223 operative. Thus, whereas the wireless power transmitter 223 is generally desired to be available at all times, lights can be independently turned on and off.

The wireless power transmitter 223 receives power from the power splitter 222. As mentioned above, wireless power transmitters 223 are usually designed to be on (i.e., powered) most or all of the time. Depending on the type, wireless power transmitters 223 may power certain loads and not others, may turn off if the load is too heavy, or may even turn off when power is expensive. Generally, however, these refinements are exceptions to the rule that wireless power transmitters 223 should have power available at all times, without regard to the state of the light 224 being turned on or off.

The light 224 also receives power from the power splitter 222. In one embodiment the light 224 comprises LEDs, but other light sources can also be used in other embodiments. In embodiments where at least one light 224 is not integrated into the device 200, one or more light sockets may be provided instead.

In some embodiments, in addition to the features discussed above of the device 200, the power splitter 222 of the device 200 may contain additional components of a control system that sends power to the wireless power transmitter 223 and/or the light 224. For example, the power splitter 222 may also include ballast compensation 2221 and/or a power usage monitoring and management module 2222.

The ballast compensation 2221 is a set of circuitry used to compensate for ballasted fixtures. Ballasts output high voltage alternating current through a coil. The input to the wireless power transmitter 223 may be designed with a circuit that does not capacitively or inductively load the ballast. Therefore, under usual conditions, the voltages and currents from ballasts are not usable to wireless power transmitters 223. Thus, ballast compensation 2221 may be used to rectify and regulate the power flowing to the wireless power transmitter 223. Usually fluorescent fixtures use high AC voltage with a low current. Wireless power systems may require DC current, usually at a lower voltage. Ballast compensation 2221 may include a step-down transformer followed by a rectifier such as a diode bridge and capacitor to form a linear power supply. Switching power supplies can also be used. Alternatively, the wireless power transmitter 223 may itself contain the circuitry to rectify and regulate the power flowing to it. Secondly, ballasts may not be designed for the additional peak power required by the wireless power transmitter 223. Power usage monitoring and management 2222 can meter the flow of power into the system, rationing power between the lighting and power output, and if necessary, throttle the power. In some implementations, it may also be necessary to use more efficient means of lighting, such as LEDs for the light 224. In many of these examples above, the power flowing from the power splitter 222 to the wireless power transmitter 223 may need ballast compensation 2221 to compensate for the ballast. This ballast compensation 2221 is not required in an unballasted fixture.

For either ballasted or unballasted fixtures, it may be useful to have a power usage monitoring and management module 2222 containing additional circuitry to monitor and manage power usage. Wireless power transmitters 223 will sometimes draw more power than a light fixture with only light bulbs or tubes would. It may be necessary to manage power consumption so that the power to the individual fixture does not exceed its safe and efficient operating limits. For example, the contacts and wiring in light fixtures may be designed only for the amount of power necessary to operate the lights, with little margin beyond or little headroom for peak power requirements. It also may be necessary to manage power consumption so that power consumption does not exceed the limits of the circuit breakers or wiring for the entire circuit. For example, a circuit may have been designed initially only for the load of a specific number of lights 224, but the addition of a wireless power transmitter 223 may significantly add to the load. Similarly, a power usage monitoring and management module 2222 may be used to coordinate power consumption by several wireless power transmitters 223 in some embodiments. The power transmitters 223 may take turns operating or operate below their normal ratings.

2. Device Including Wireless Power Transmitter with Light Bulb or Tube Form

A device including a wireless power transmitter 223 may be designed to have the form of a light bulb or tube and fit in the place of a standard light bulb or tube. This arrangement has several advantages: 1) ease of installation—most people know how to install a light bulb, 2) guaranteed fit in a standard fixture, 3) the light from the transmitter can be designed to substitute well for the light from the fixture; 4) by using LEDs, it can even be more efficient than the bulb or tube it replaces; and 5) aesthetically, the light fixture was designed for this form, and so it is likely to be more attractive than a solution not in the form of the bulb or tube.

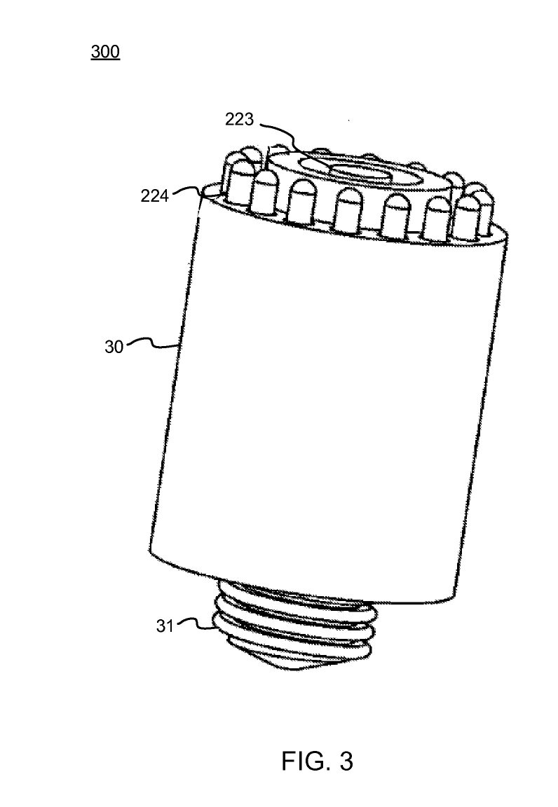

FIG. 3 illustrates one embodiment of a device 300 having a wireless power transmitter 223, wherein the device 300 is substantially in the form of a light bulb. The device 300 is designed to screw into a light fixture in the place of a light bulb. Screw 31 has the electrical contacts for the light fixture 221 and mechanically holds the other components of the device 300. In this embodiment, the device 300 includes a wireless power transmitter 223 substantially within the housing 40 of the device 300, but extending to the end of the housing furthest from the screw 31, in order to provide enhanced line of sight for wireless power transmitters 223 that require line of sight to transmit power to remote devices. The device 300 also includes LEDs as lights 224 positioned at the end of the housing 30 to emit light, but alternatively or additionally, other light emitters can be used. In other embodiments, the device 300 simply provides a socket for the light or lights 224 without including them in the device 300. Also, as described above with reference to FIG. 2, a power splitter 222 may be provided within the device 300, for example within housing 30, to allow the lights 224 to be controlled separately from the wireless power transmitter 223.

### 3. Device Including Wireless Power Transmitter Without Light Bulb or Tube Form

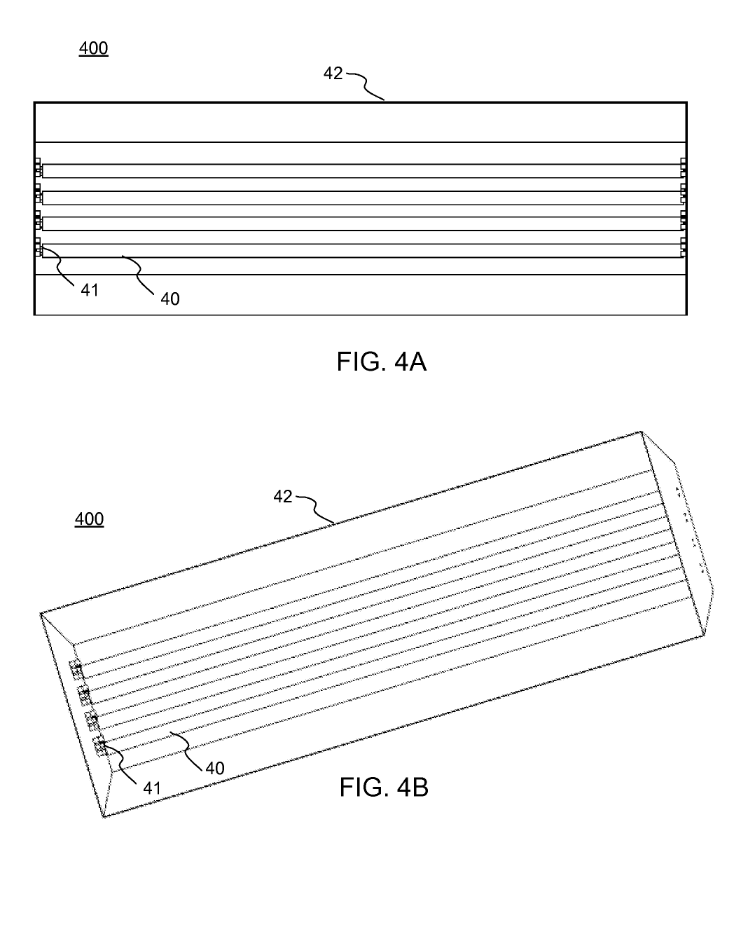

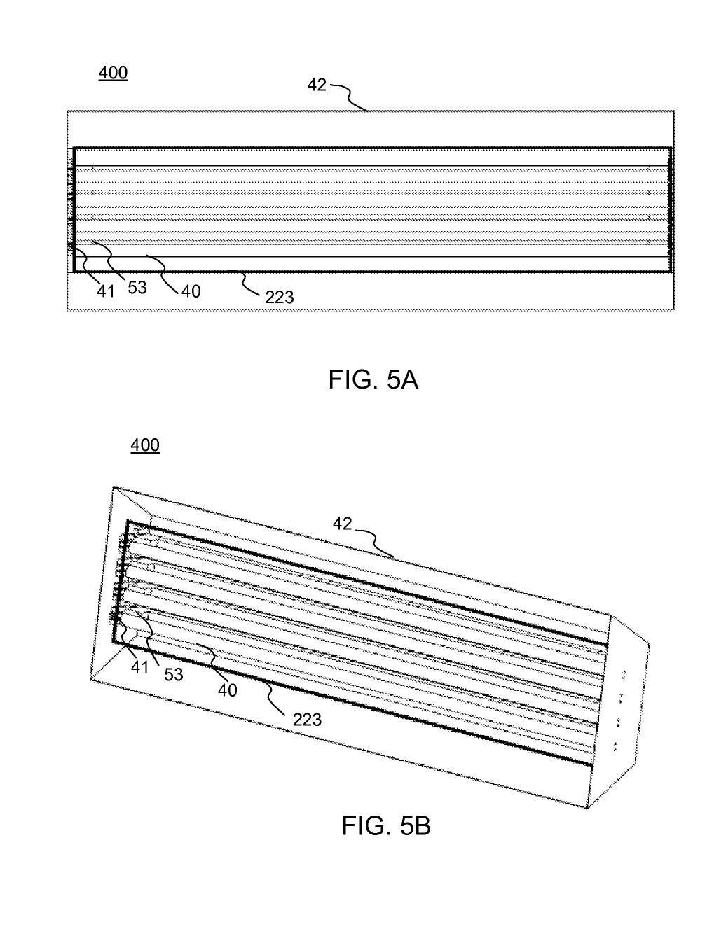

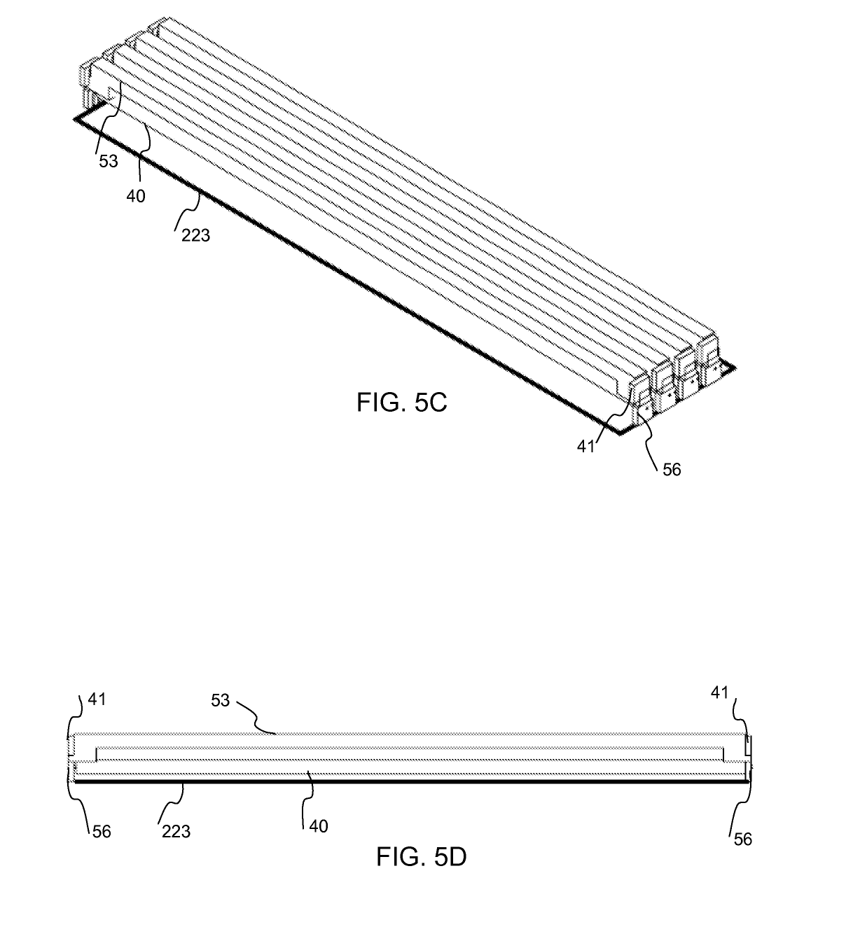

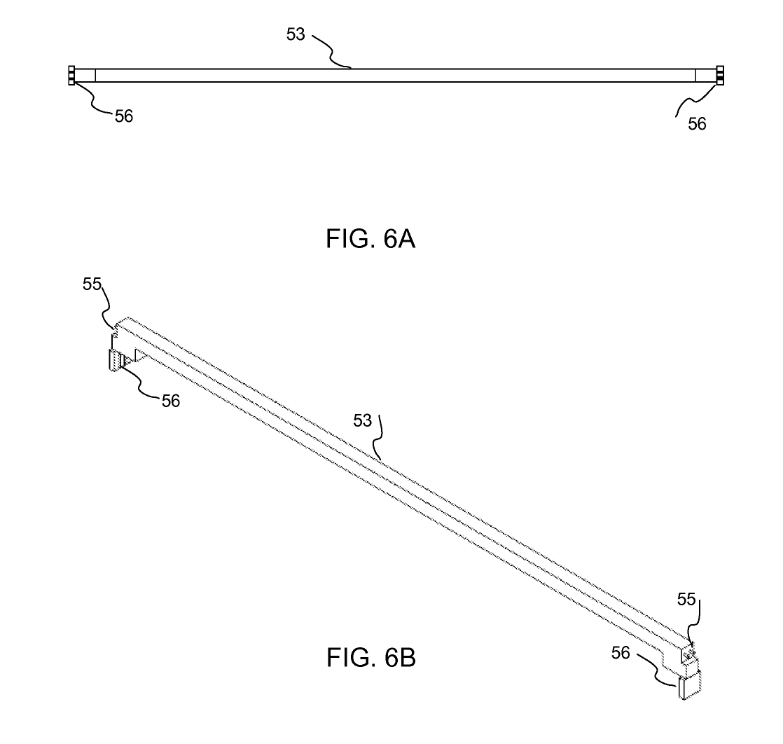

Some wireless power transmitters 223 have large transmit parts, and it may be difficult to engineer them to fit into the position and space in the light fixture provided for a standard light bulb or tube. Some systems cannot transmit through ferrous metal, and many light fixtures are made of sheet steel. In these cases, it may be preferable to mount the wireless power transmitter 224 near to the light fixture and run a connection to the contacts for the light. However, light fixtures are not outlets. For safety reasons, the electrical contacts are not exposed. In these embodiments, an intermediate is used to take power from the electrical contacts, as described with reference to element 221 of FIG. 2. FIGS. 4A and 4B illustrate a standard fluorescent light fixture 400, and FIGS. 5A-D illustrate the fixture 400 of FIGS. 4A and 4B as modified to include a built-in wireless power transmitter 223 that is connected to the fixture 400 through an intermediate 53. FIGS. 6A and 6B illustrate the intermediate 53 in isolation.

FIG. 4A shows a bottom view of a standard fluorescent light fixture 400, for example, as designed to hang from the ceiling, and FIG. 4B shows an isometric view of the fixture 400. The fixture 400 includes a case 42 and standard fluorescent tubes 40 inserted into sockets 41. The case 42 is the shroud on which the sockets 41 are attached. Usually the case 42 is made of sheet metal, but other materials may also be used. The sockets 41 attach the tubes 40 mechanically to the fixture 400 and contain the electrical contacts that provide the fluorescent tubes 40 electricity. For safety reasons, when the tube 40 is inserted in the socket 41, the contacts are usually not visible or accessible. For simplicity, no ballast is shown in FIG. 4A or 4B, but these fixtures 400 are usually ballasted.

FIGS. 5A and 5B illustrate the fixture 400 shown in FIGS. 4A and 4B as modified to include a built-in wireless power transmitter 223, in accordance with one embodiment. In this case, the wireless power transmitter 223 is in the form of a coil of wire attached to a control box. For example, a resonant magnetic wireless electricity transmitter 223 may have a similar shape to that shown in FIGS. 5A and 5B. In one embodiment, the control box resides inside of the intermediate 53, which will be described in further detail below, but in other embodiments the control box may reside outside of the intermediate 53. The control box may control the timing and amount of power supplied as well as authentication of potential receivers. It may also contain analog electronics to drive the coils. It may be desirable to locate a power splitter 222 in the control box, which makes it electrically intermediate between the fixture and the lights. FIGS. 5A and 5B illustrate the use of an intermediate 53 which functions to make electrical connection to contacts on the light fixture 400. Note that a standard light tube 40 can be used if an intermediate 53 is provided. The intermediate 53 also functions as the power splitter 222 described with reference to FIG. 2. It provides the ability to turn off the tubes 40 while the power remains on to the wireless power transmitter 223.

FIGS. 5C and 5D are an isometric view and a front view, respectively, of a fixture 400 with the case 42 suppressed to allow observation of the arrangement of the parts inside. Sockets 41 are attached to the case 42, and as mentioned above, they usually provide mechanical support for the tubes 40 as well as electrical contacts. In this case, the intermediates 53 are inserted in the sockets 41 (in place of the tubes 40). The tubes 40 are then inserted in the intermediate sockets 56. It is not necessary for the same size tubes 40 to be used as the light elements, nor is it necessary for intermediate 53 to span the fixture 400. The tube 40 can be substituted with many different light sources, and the shape of the intermediates 53 can be different in other implementations of the invention. The embodiment shown is simply convenient because tubes 40 are available and inexpensive, and by moving the tube 40 out from the case 42 by a distance on the order of the depth intermediate 53, the light from the tube 40 still covers substantially the same area that the fixture 400 was designed for it to cover.

FIGS. 6A and 6B show an example of a front view and an isometric view, respectively, of the intermediate 53 in isolation. As described above, this intermediate 53 can span between two sockets 41 spaced for a standard size fluorescent tube. Although spanning between two sockets 41 is mechanically convenient, it is not necessary. In other embodiments, other forms of intermediates 53 are used. In this example, contacts 55 of the intermediate 53 fit the existing sockets 41 of a fixture 400. Intermediate sockets 56 provide a place for a tube 40 to be connected to intermediate 53 in order to draw power through the intermediate 53 in order for the tube 40 to emit light. In this embodiment, the intermediate sockets 56 are designed to have the same spacing as light sockets 41 on the fixture 400 so that a standard size tube 40 will fit properly. In addition, intermediate 53 may also contain additional electronics, such as for power conditioning or for networking of the wireless power transmitters 223. For example, the intermediate 53 may contain the power splitter 222 discussed with reference to FIG. 2. For clarity, FIGS. 6A and 6B do not show connectors to the wireless power transmitter 223, however such connectors are configured to feed power through the intermediate 53 to the wireless power transmitter 223.

For embodiments that use optical wireless power transmitters 223, it is noted that some optical wireless power transmitters 223 do not work well through the diffusers of some fluorescent light fixtures. In these cases, the diffusers can be removed, or a diffuser can be put on or near each tube 40 and a clear material can replace the diffuser through which the optical wireless power transmitter 223 transmits.

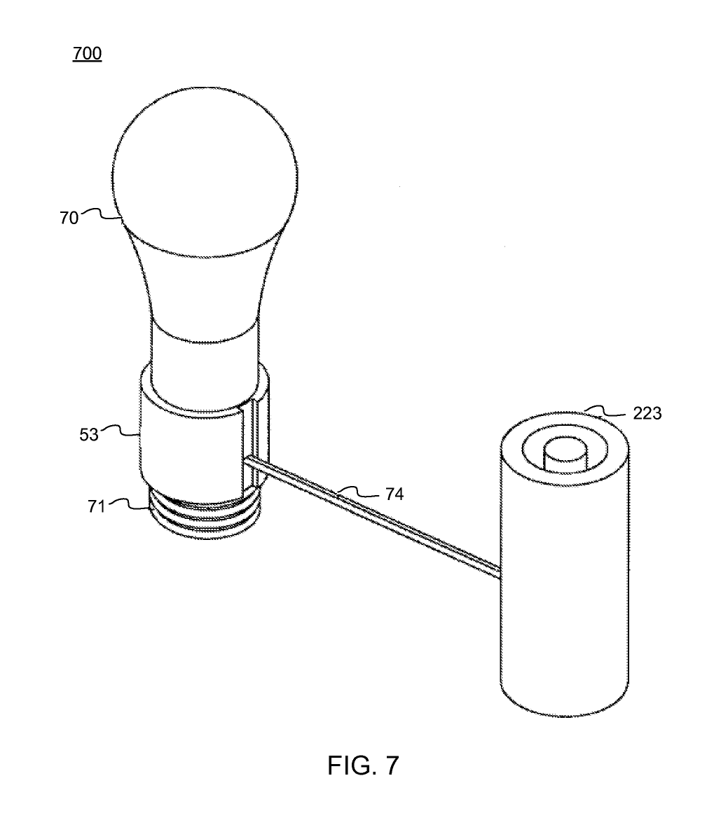

FIG. 7 shows another embodiment of a device 700 including a wireless power transmitter 223, wherein the device 700 does not have light bulb form. The device 700 includes a screw mount 71, an intermediate 53, a light 70, a wire 74, and a wireless power transmitter 223. The screw mount 71 screws the device 700 into a light fixture in the place of a standard light bulb. The screw mount 71 provides the electrical connection to the contacts on the light fixture as discussed with reference to element 221 of FIG. 2. An intermediate 53 is used to take power received through the screw mount 71 from the contacts on the light fixture and functions as a power splitter 222 described above. The intermediate 53 functioning as the power splitter 222 may also contain ballast compensation 2221 and a power usage monitoring and management module 2222 to control power to the light 70 and the wireless power transmitter 223, as described above. The intermediate 53 is connected to wireless power transmitter 223 through a wire 74 or similar electrical connection. Thus, the wireless power transmitter 223 may be mounted separately from the light 70, for example, in the vicinity of the light 70 on the wall or ceiling.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention.

1. An apparatus comprising:
an electrical connection to contacts on a light fixture;
a wireless power transmitter coupled to the electrical connection; and
a power splitter, the power splitter electrically intermediate between the electrical connection and the wireless power transmitter and electrically intermediate between the electrical connection and a light source or light socket, the power splitter configured to provide power selectively and independently to the wireless power transmitter and the light source or light socket.

2. The apparatus of claim 1, wherein the electrical connection comprises a screw mount.

3. The apparatus of claim 1, further comprising a light source.

4. The apparatus of claim 1, wherein the power splitter further comprises ballast compensation to compensate for ballasted light fixtures.

5. The apparatus of claim 1, wherein the power splitter further comprises a power usage monitoring and management module to monitor power usage by the apparatus.

6. The apparatus of claim 1, wherein the device is substantially in the form of a light bulb.

7. The apparatus of claim 1, wherein the device is substantially in the form of a light tube.

8. The apparatus of claim 1, wherein the electrical connection to contacts on a light fixture comprises an intermediate including sockets into which a fluorescent tube fits.

9. The apparatus of claim 8, wherein the intermediate spans between two sockets of a light fixture, and the intermediate includes sockets into which a standard size fluorescent tube fits.

10. The apparatus of claim 9, wherein the intermediate comprises the power splitter.
